(19) United States
(12) Patent Application Publication
(10) Pub. No.: US 2007/0091168 A1
(43) Pub. Date: Apr. 26, 2007

(54) Method to support simultaneous wireless connection of multiple media components

(76) Inventor: Hyun Lee, Ladera Ranch, CA (US)

Correspondence Address: Hyun Lee, 21 Thalia St, Ladera Ranch, CA, 92694, US

(21) Appl. No.: 11/585,590

(22) Filed: Oct. 24, 2006

Related U.S. Application Data
(63) Continuation of application No. 60/730,152, filed on Oct. 25, 2005.

(51) Int. Cl. H04N 7/14

(52) U.S. Cl. 348/14.01

(57) ABSTRACT

The wireless connectivity method in this invention achieves simultaneous wireless operation of a number of various individual media components. Here, a media component, or a media equipment, is defined as an electronic device that records, receives, transmits, and/or produces audio/visual information or data for various purposes such as but not limited to entertainment, education, business, government, etc. These media components include but are not limited to analog and digital components such as: televisions video display monitors; DVD players and or recorders; television set top boxes, Home Gateways, Personal Video Recorders (PVRs), video cameras, digital still cameras, video cassette players and or recorders, compact discs, audio components, speakers, personal computers (PCs), IPods, MP3 Players, Game Players such as XBOX, Nintendo, PlayStation, PSP, etc.

### RELATED APPLICATIONS

The present application is a continuation application of U.S. provisional patent application, Ser. No. US60/730.152, filed Oct. 25, 2005, for METHOD TO SUPPORT SIMULTANEOUS WIRELESS CONNECTION OF MULTIPLE MEDIA COMPONENTS, included by reference herein and for which benefit of the priority date is hereby claimed.

### FIELD OF THE INVENTION

The present invention relates to the fields of home and business networking and, more particularly, and to a wireless entertainment system using various standard communication protocol translation methods.

### BACKGROUND OF THE INVENTION

Generally, the prior art employs a PC to control the entertainment/data communication among media equipment. Current wireless networks (whether or not they involve entertainment components) are designed to be controlled by a single device, where all information/data transfers are generally conducted through a PC using a communication protocol that is supported by the PC, commonly the 802.11, Ethernet protocol, 1394 Firewire, and/or WUSB. This approach introduces a serious deficiency in supporting the newly emerging consumer market by not being able to provide simultaneous information/data transfers between multiple media components. In other words, the prior art of wireless system does not address a way of supporting communication involving multiple data streams running simultaneously between different media components, which utilize similar or different communication protocols.

For example, if a wireless entertainment system user wants to view a movie from a set top box while recording another movie from the set top box using a DVD recorder, he would not be able to do this with any currently existing wireless system using a PC centric communication protocols, since the Consumer Electronic manufacturers develop video/audio media protocols (such as DVI, HDMI, HDCP) that are not compatible with their data transfer protocols (such as 1394, USB, FCS, Security protocol).

This example situation can be further complicated if a second user wants to watch a different movie via Ethernet while the first user is still watching and recording his/her movies, since the PC has limited computational resources to process multiple media channels simultaneously in real time. These examples show the inadequacies of the currently available wireless system architectures that they are unable to support many users that desire simultaneous wireless operations among various video/audio media components, especially those that operate under different protocols.

As it was mentioned previously, the main deficiency is due to the fact that all media communication protocols need to support the real-time, non-delayed operation (or isochronous operation) while data communication protocols generally operate in a non-real time, store-and-forward fashion.

To support the multiple simultaneous wireless communication channels, The electronic industry developed new IEEE standards such as 802.16e, WiBro, WiMax.

These new standards cover a longer physical distance, but do not provide the data bandwidth that requires supporting a large number of wireless devices that would reside in the physical domain that these standards cover. In fact, these standards were developed to support the type of network model that is comparable with the WiFi (802.11) type network, where the data download rate far excesses the data upload rate.

Therefore, these standards would likely better adopt for the application such as HDTV broadcasting. However, considering that there are a large number of small networks, such as Personal Area Network (PWN), within the covering range, and each network would need to operate independently supporting multiple simultaneous multi-directional high bandwidth communication, these standards would not fit presents serious deficiency

It is therefore an object of the invention to provide a method to support simultaneous wireless connection of multiple media components.

It is another object of the invention to present the method to wirelessly connect multiple devices with different protocols.

It is another object of the invention to present the concept of the Communication Traffic Controller (CTC), which controls wireless connections among the entertainment network, the data communication network, and mobile network

It is another object of the invention to show how to provide direct wireless connection between two communication devices, which may or may not share the same communication protocols

It is another object of the invention to present a method of how to build a wireless network that automatically fully utilizes all the available channels.

### SUMMARY OF THE INVENTION

In accordance with the present invention, there is provided the idea supporting simultaneous and seamless wireless operations among multiple media components with the same or different communication protocols, such as HDMI, HDPC, DVI, USB, 1394, Ethernet, and analog signal.

The foundation of this solution is the Communication Traffic Coordinator (CTC), which controls wireless connections between the entertainment network and the data communication network. The CTC could be integrated into a Set Top Box or a TV. The CTC coordinates the wireless traffic among the entertainment equipment, and it could become the access point to a data communication network, which may employ a set of different protocols than the wireless entertainment network

### BRIEF DESCRIPTION OF THE DRAWINGS

A complete understanding of the present invention may be obtained by reference to the accompanying drawings, when considered in conjunction with the subsequent, detailed description, in which:

FIG. 1 is a detail view of a communication-traffic-coordinator (ctc) that is composed of two layers of switches and a controller/translator;

FIG. 2 is a detail view of a router in the ctc. it consists of two rf phy ports, a data router, and a controller;

FIG. 3 is a detail view of a tuner/transmitter (tt), which converts an outgoing data format into common data format before transmitting the converted data to the ctc or to a target tuner/receiver (tr);

FIG. 4 is a detail view of a tuner/receiver (tr), which converts an incoming data format into the appropriate data format that the target component understands;

FIG. 5 is a detail view of a way of establishing a point-to-point communication without ctc;

FIG. 6 is a detail view of a way that tt may broadcast without ctc; and

FIG. 7 is a detail view of a ctc, which dynamically re-routs each data path by assigning the vwp to different carrier frequencies to ensure qos.

For purposes of clarity and brevity, like elements and components will bear the same designations and numbering throughout the Figures.

### DESCRIPTION OF THE PREFERRED EMBODIMENT

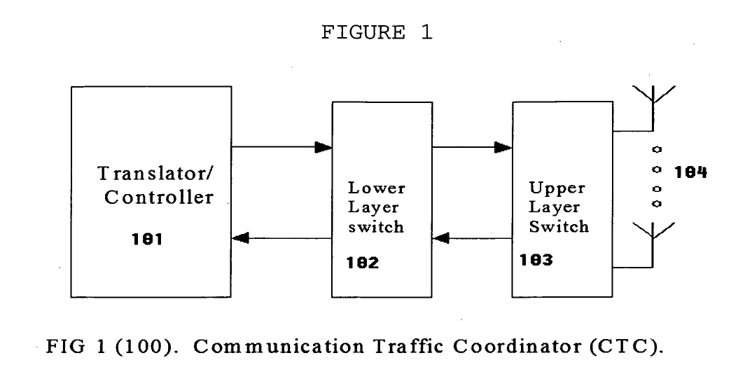

FIG. 1 is a detail view of a communication-traffic-coordinator (CTC 100) that is composed of two layers of switches and a controller/translator.

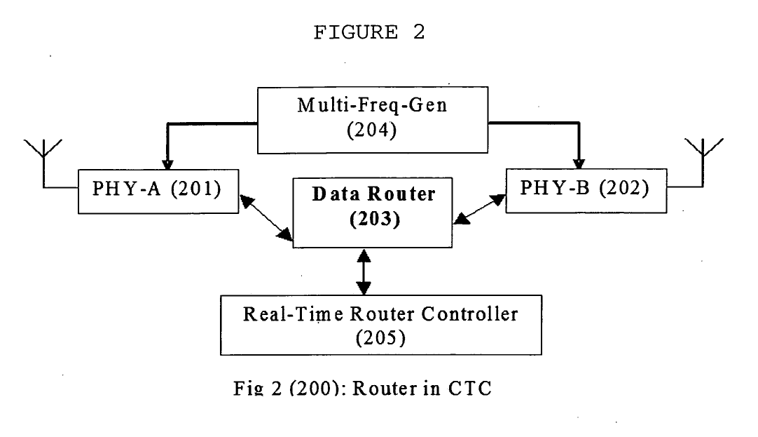

FIG. 2 is a detail view of a router 200 in the CTC 100. it consists of two rf 104 phy ports, a data router 203, and a controller.

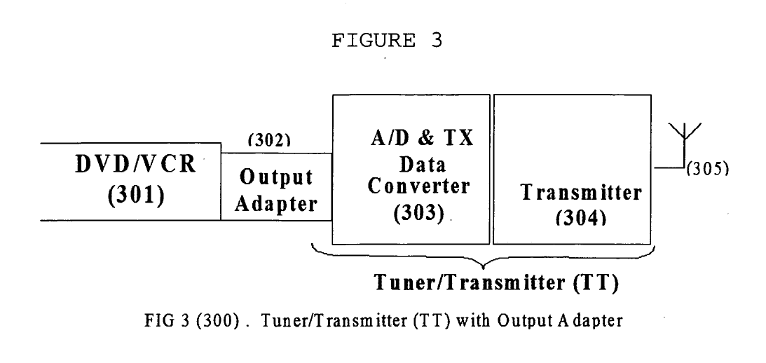

FIG. 3 is a detail view of a tuner/transmitter 304 (TT 501), which converts an outgoing data format into common data format before transmitting the converted data to the CTC 100 or to a target tuner/receiver 402 (TR 503).

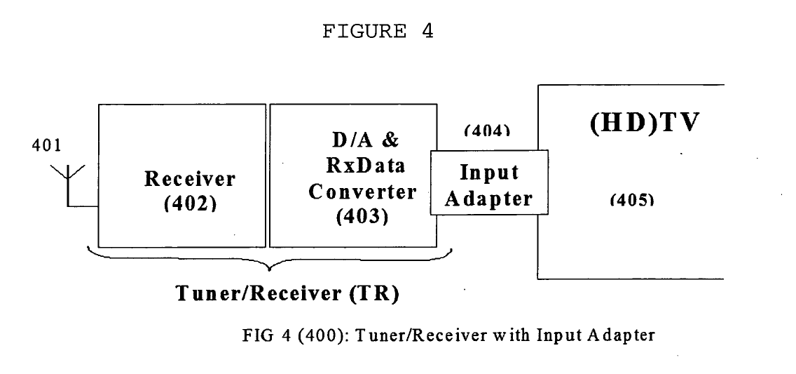

FIG. 4 is a detail view of a tuner/receiver 402 (TR 503), which converts an incoming data format into the appropriate data format that the target component understands.

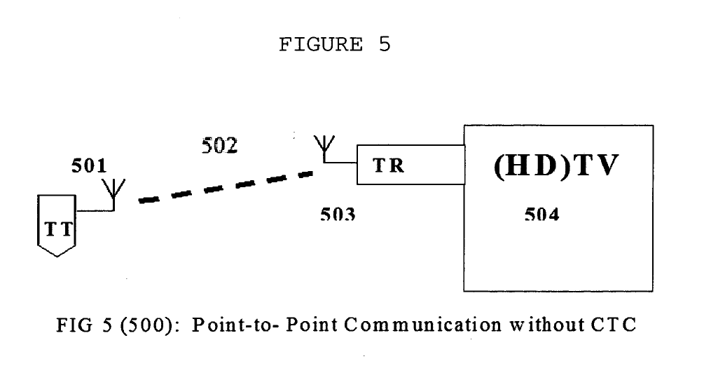

FIG. 5 is a detail view of a way of establishing a point-to-point communication without CTC 100.

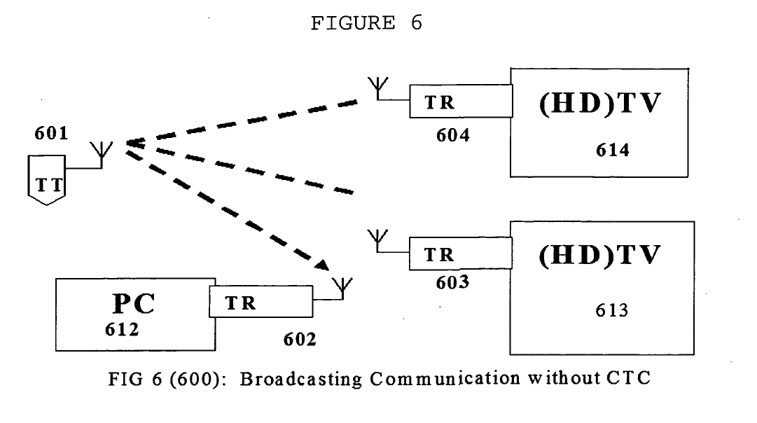

FIG. 6 is a detail view of a way that TT 501 may broadcast 600 without CTC 100.

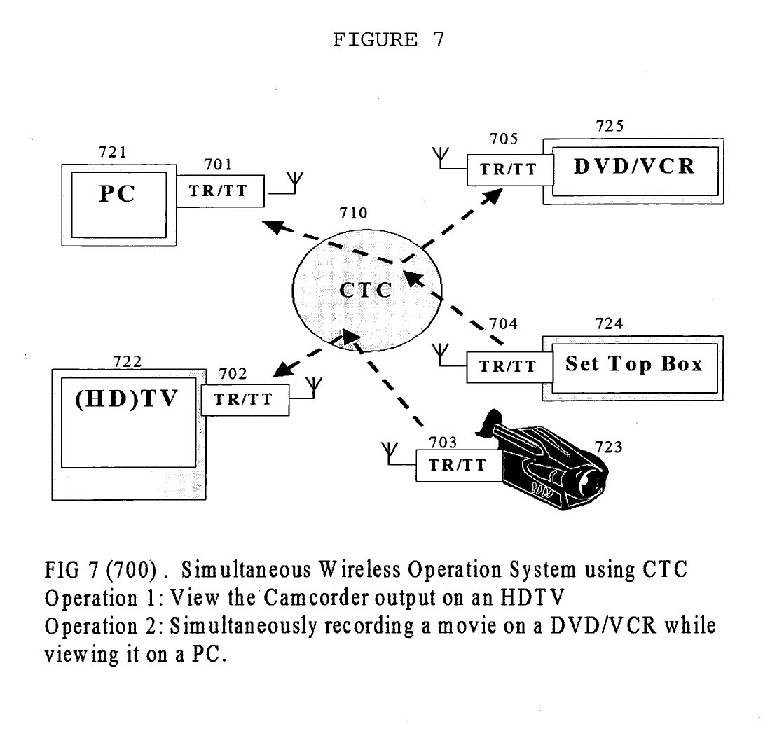

FIG. 7 is a detail view of a CTC 100, which dynamically re-routs each data path by assigning the vwp to different carrier frequencies to ensure qos.

This patent application describes a Simultaneous Wireless Operation System, which consists of a Tuner/Receiver 402 (ex. UWB PHY) (400), a Tuner/Transmitter 304 (ex. UWB PHY Controller) (300), and a Communication-Traffic-Coordinator (CTC 100) (100). The CTC 100 can be implemented as a UWB device or other standard or proprietary protocol that connects to the same or different communication protocols.

The Communication-Traffic-Coordinator (CTC 100) (100) is composed of two layers of switches and a controller/translator. The lower layer is a time-multiplexing and/or frequency-multiplexing switch (ex. firmware controlled UWB MAC); the upper layer is an optional frequency-hopping switch (ex. firmware controlled PHY). The Lower Layer Switch 102 operates at a speed that can support multiple upper layer switches (100), such that multiple simultaneous wireless media connections can occur on different frequencies or channels. The controller/translator controls the wireless packet traffic by performing various tasks such as protocol translation, flow control, store-and-forward or direct redirection (real-time router 200 function), protocol translation and collision detection, etc.

Each router 200 200 in the CTC 100 100 consists of two RF 104 PHY ports (201), the Data Router 203 (203), the Multi_Freq-Gen (204), and the Real-Time Router Controller 205 (205). The data router 203 (203) exams the source and destination address, and it asserts and/or converts the DA field in the packet header. The Multi-Freq-Gen 204 (204) generates different mixer frequency for the modulation of the PHYs (201) to match with the modulation of the source and destination PHYs. The Real-Time Router Controller 205 assigns the packet priority and bandwidth for the real-time signals.

A Protocol Translator Layer in the Tuner/Transmitter 304 (TT 501) converts an outgoing data format into common data format before transmitting the converted data to the CTC 100 or to a target Tuner/Receiver 402 (TR 503) (300).

A Protocol Convergence Layer in the Tuner/Receiver 402 (TR 503) converts an incoming data format into the appropriate data format that the target component understands. (400)

The wireless connection of media components can operate in two basic modes: Direct Communication (DC) mode, and Indirect Communication (IC) mode.

DC mode allows communication between two or more entertainment components via a pre-selected carrier frequency without any assistance of the CTC 100.

In IC mode, the CTC 100 dynamically assigns a carrier frequency to each media component, and may change the frequency to enhance the QoS and the data throughput rate.

Direct Communication (DC) Mode

Point-To-Point Communication:

This mode allows a user to establish a wireless link (connection) between a pair of media components without the use of a CTC 100. A user pre-selects a common carrier frequency for both of the components by setting a switch on the TT 501/TRs, prior to plugging TT 501/TRs into the receptacles on the components (500). TT 501 and TR 503 communicate with each other via this frequency until the user changes the selection. If the user needs to establish data transfer between more than a pair of components, different carrier frequencies need to be assigned to each pair of components.

Broadcasting:

This mode allows a user to broadcast 600 data to multiple components by setting one TT 501 and multiple TRs to the same frequency, or, if the TRs are set at different frequencies, the TT 501 may broadcast 600 to those separate frequencies (600).

Indirect Communication (IC) Mode

When this mode is invoked, the CTC 100 initializes the carrier frequency for each TT 501 and TR 503 such that the CTC 100 dynamically establishes virtual wireless paths (VWPs) between various TTs and TRs. The CTC 100 also dynamically re-routs each data path by assigning the VWP to different carrier frequencies to ensure QoS (700).

Time Multiplexing packets

Generally, low data rate signals such as control and interrupt packets are time multiplexed. The CTC 100 receives all the data transmitted from various components (TTs) and time multiplexes and formats them into a data packet before it broadcasts the components in a certain frequency which is assigned to carry all control, interrupt, and handshake information. Each target component (TR 503) intercepts the broadcast 600 signal and extracts the relevant information. The control and interrupt packets are delivered to the TRs via a user set data rate.

Data Packets

The wireless communication occurs via data packets that are generated by the TTs and the CTC 100. Data packets are generally assigned to a carrier frequency that is dedicated for a Communication Group (CG), which consists of one TT 501 and one or more TRs. The format of each data packet assumes various industry standard packets, such as the Ethernet, 1394, USB, etc. However, the TT 501, TR 503, and CTC 100 wrap each data packet in a carrier packet that is encoded/decoded. Each TR 503 tunes its receiver 402 frequency according to instruction given by the control packet (refer to the Time Multiplexing)

If the original data is in the form of analog signals, then the user has the option to convert the analog signal into a digital signal, or send the analog signal directly via a carrier. In case of transmitting analog signals, the TT 501 adopts the technique such as AM or FM modulation.

Communication Channel 502 502 Assignment

The CTC 100 dynamically assigns a channel to a Communication Group (CG). Once a channel is assigned to a CG, it remains the same until the CG ceases to exist. For example, a CG may consist of many components, but any active TT 501/TR 503 pair in the CG constitutes the existence of the CG.

Data Type

There are four types of data communication, Real Time Data (RTD—or Isochronous data), Non-Real Time Data (NRTD), Control/Interrupt Data (CID), and Analog Data (AD). The RTD supports real time audio/video data stream such as viewing a movie. The NRTD type is used for communication or recording of data.

Real Time Data (RTD): Neither CTC 100 nor TT 501 stores any RTD data for re-transmission since the RTD data are all transient data that require in-time delivery.

Non-Real Time Data (NRTD): CTC 100 and TT 501 store all RTD data for re-transmission when a receiver 402 responds with a Communication Error Interrupt (CEI) signal to the source. These NRTD support all non-real time data transfers to components such as printers, Hard Disks, DVD/CD/VHS dubbing, file transfer between two components, etc.

Control/Interrupt Data (CID): Either CTC 100 or TT 501 can generate CID data. This data type only transfers control and interrupt information.

Analog Data (AD): The CTC 100 establishes a CG frequency that the TT 501 and TR 503 use as the carrier frequency. This method supports the transmission of RGB signals using frequency modulation without the costly method of converting analog signals to digital and back to analog.

Communication Error Handling:

If any receiver 402 (TR 503) sends a Communication Error Interrupt (CEI) signal to a source, the source is required to retransmit the (NRTD) data. The source sends out an Interrupt packet to all TRs indicating an occurrence of an error, and takes either of the following actions, depending on the source.

Tuner/Transmitter 304 (TT 501): A TT 501 broadcasts an interrupt packet to all TRs with the information of which data packet caused the error, and it retransmits the NRTD data from the failed packet. If an error was associated with a CID packet, the transmitter 304 retransmits only the portion of control/interrupt information that was targeted to the particular TR 503 that reported the error.

In general, if a CTC 100 is present, a TT 501 only communicates with the CTC 100 for all data transfer and control/interrupt transfers. The CTC 100 redirects the data traffic to ensure the QoS.

Communication-Traffic-Coordinator (CTC 100): A CTC 100 basically takes the same action as a TT 501. However, it may exercise its option to change the carrier frequency if it detects a higher error rate on a particular frequency over other frequencies. In this case, the CTC 100 sends a CID packet to the targeted TRs, requesting them to adjust their receiver 402 tuners to a new frequency. The CTC 100 also serves as a data format translator between TT 501 and TR 503. For example, a CTC 100 may convert the data format from a PC 721 to another data format that is incompatible with HDTV.

Detailed Example:

Using Direct Communication (DC) Mode—This is the default operation mode, which requires a Tuner/Transmitter 304 (TT 501) and a Tuner/Receiver 402 (TR 503). A TT 501 (TR 503) contains two distinct network interfaces: a media equipment I/O interface and a Wireless interface. For example, a TT 501 that is connected to an analog audio equipment and a TR 503 is connected to a stereo speaker. The TR 503 two copper wires interfaces with the stereo, and a wireless communication interfaces to talk with a TR 503. The TR 503 contains a wireless receiver 402 and sends a demodulated analog signal to the stereo speaker. This arrangement provides an added comfort to a user by not restricting the physical location of the analog audio equipment from the stereo speaker. With a TT 501 and a TR 503, the user now can send analog signals from a distance, and thus has the freedom to move around.

Using Direct Broad Casting Mode—This mode allows a user to connect all home theater speakers wirelessly. A TT 501 is connected to a receiver 402/amplifier and a TR 503 is attached to each speaker. This arrangement gives freedom to install/move the speakers anywhere without rewiring speaker cable behind walls.

Indirect Communication (IC) Mode—This mode allows a user to simultaneously transfer information among various equipments including PCs and printers. A user can dub a movie from a DVD player to a PC 721 while watching on a HDTV.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A method to support simultaneous wireless connection of multiple media components for supproting simultaneous and seamless wireless operations among multiple media components with the same or different communication protocols, such as hdmi, hdpc, dvi, usb, 1394, ethernet, and analog signal, comprising:
means for controlling the wireless communication. communication-traffic-coordinator (ctc) can be implemented as a uwb device or as a device that supports a proprietary wireless protocol. the ctc connects devices with the same or with different communication protocols;
means for converting an outgoing data format into common data format before transmitting the converted data to the ctc or to a target tuner/receiver (tr);
means for converting an incoming common data format into the appropriate data format that the target component understands;
means for representing the case when a user pre-selects a common carrier frequency for both of the components by setting a switch on the tt/trs, prior to plugging tt/trs into the receptacles on the components;
means for the mode that allows a user to broadcast data to multiple components by setting one tt and multiple trs to the same frequency, or, if the trs are set at different frequencies, the tt may broadcast to those separate frequencies;
means for the case that the ctc dynamically re-routs each data path by assigning the virture wireless path (vwp) to different carrier frequencies to ensure qos;
means for translating the communication protocol when the transmitter and receiver protocols are not the same;
means for multiplexing and/or spreading for the tdma, the fdma, tds, fds, etc, tightly connected to said means for translating the communication protocol when the transmitter and receiver protocols are not the same;
means for optional frequency-hopping switch (ex. firmware controlled phy), tightly connected to said means for multiplexing and/or spreading for the tdma, the fdma, tds, fds, etc;
means for physical interface layer such as anntenas with baseband;
means for routing the data from on physical wireless device to another physical wireless device. the router provides wireless connectivity among multiple wireless devices whose communication protocols may not be the same;
means for checking the source and destination address, and it asserts and/or converts the da field in the packet header;
means for representing the tt (300) in the wireless network that provides the point-to-point connection between one transmitter and one receiver regardless of the difference in the communication protocols between the transmitter and the receiver;
means for representing the tr (400) in the wireless network that provides point-to-point connection between one transmitter and one receiver regardless of the difference in the communication protocols between the transmitter and the receiver;
means for representing a tt with broadcasting capability (to the receivers with various communication protocols);
means for representing one of many receivers that may convert the protocol of the received packet to another protocol for the pc (612), operationally connected to said means for representing a tt with broadcasting capability (to the receivers with various communication protocols);
means for representing one of many receivers that converts the received signal to hdtv format, operationally connected to said means for representing a tt with broadcasting capability (to the receivers with various communication protocols);
means for representing a ctc with multiple groups of wireless channel connection;
means for providing wireless interface to the pc or other pc centric devices, operationally connected to said
means for representing a ctc with multiple groups of wireless channel connection;
means for providing wireless interface to the (hd)tv or other entertainment devices, operationally connected to said means for representing a ctc with multiple groups of wireless channel connection;
means for providing wireless interface to camera/camcoder or other mobile devices, operationally connected to said means for representing a ctc with multiple groups of wireless channel connection;
means for providing wireless interface to the settop box or other gateway devices, operationally connected to said means for representing a ctc with multiple groups of wireless channel connection; and
means for providing wireless interface to dvd/vcr or other storage devices, operationally connected to said
means for representing a ctc with multiple groups of wireless channel connection.

2. The method to support simultaneous wireless connection of multiple media components in accordance with claim 1, wherein said means for controlling the wireless communication. communication-traffic-coordinator (ctc) can be implemented as a uwb device or as a device that supports a proprietary wireless protocol. the ctc connects devices with the same or with different communication protocols comprises a component ctc.

3. The method to support simultaneous wireless connection of multiple media components in accordance with claim 1, wherein said means for the mode that allows a user to broadcast data to multiple components by setting one tt and multiple trs to the same frequency, or, if the trs are set at different frequencies, the tt may broadcast to those separate frequencies comprises a broadcast.

4. The method to support simultaneous wireless connection of multiple media components in accordance with claim 1, wherein said means for the case that the ctc dynamically re-routs each data path by assigning the virture wireless path (vwp) to different carrier frequencies to ensure qos comprises a wireless system with ctc.

5. The method to support simultaneous wireless connection of multiple media components in accordance with claim 1, wherein said means for translating the communication protocol when the transmitter and receiver protocols are not the same comprises a module translator controller.

6. The method to support simultaneous wireless connection of multiple media components in accordance with claim 1, wherein said means for multiplexing and/or spreading for the tdma, the fdma, tds, fds, etc comprises a module lower layer switch.

7. The method to support simultaneous wireless connection of multiple media components in accordance with claim 1, wherein said means for optional frequency-hopping switch (ex. firmware controlled phy) comprises a module upper layer switch.

8. The method to support simultaneous wireless connection of multiple media components in accordance with claim 1, wherein said means for routing the data from on physical wireless device to another physical wireless device. the router provides wireless connectivity among multiple wireless devices whose communication protocols may not be the same comprises a router.

9. The method to support simultaneous wireless connection of multiple media components in accordance with claim 1, wherein said means for representing the tt (300) in the wireless network that provides the point-to-point connection between one transmitter and one receiver regardless of the difference in the communication protocols between the transmitter and the receiver comprises a component tt.

10. The method to support simultaneous wireless connection of multiple media components in accordance with claim 1, wherein said means for representing the tr (400) in the wireless network that provides point-to-point connection between one transmitter and one receiver regardless of the difference in the communication protocols between the transmitter and the receiver comprises a component tr.

11. The method to support simultaneous wireless connection of multiple media components in accordance with claim 1, wherein said means for representing a tt with broadcasting capability (to the receivers with various communication protocols) comprises a component tt-broadcast.

12. The method to support simultaneous wireless connection of multiple media components in accordance with claim 1, wherein said means for representing a ctc with multiple groups of wireless channel connection comprises a component ctc—multiple_connect.

13. The method to support simultaneous wireless connection of multiple media components in accordance with claim 1, wherein said means for providing wireless interface to the pc or other pc centric devices comprises a component tr/tt-pc.

14. The method to support simultaneous wireless connection of multiple media components in accordance with claim 1, wherein said means for providing wireless interface to the (hd)tv or other entertainment devices comprises a component tr/tt-hdtv.

15. The method to support simultaneous wireless connection of multiple media components in accordance with claim 1, wherein said means for providing wireless interface to camera/camcoder or other mobile devices comprises a component tr/tt-cam.

16. The method to support simultaneous wireless connection of multiple media components in accordance with claim 1, wherein said means for providing wireless interface to the settop box or other gateway devices comprises a component tr/tt-settop.

17. The method to support simultaneous wireless connection of multiple media components in accordance with claim 1, wherein said means for providing wireless interface to dvd/vcr or other storage devices comprises a component tr/tt-dvd/vcr.

18. A method to support simultaneous wireless connection of multiple media components for supproting simultaneous and seamless wireless operations among multiple media components with the same or different communication protocols, such as hdmi, hdpc, dvi, usb, 1394, ethernet, and analog signal, comprising:
a component ctc, for controlling the wireless communication. communication-traffic-coordinator (ctc) can be implemented as a uwb device or as a device that supports a proprietary wireless protocol. the ctc connects devices with the same or with different communication protocols;
a component tt with output adaptor, for converting an outgoing data format into common data format before transmitting the converted data to the ctc or to a target tuner/receiver (tr);
a component tr with input adaptor, for converting an incoming common data format into the appropriate data format that the target component understands;
a point-to-point connection, for representing the case when a user pre-selects a common carrier frequency for both of the components by setting a switch on the tt/trs, prior to plugging tt/trs into the receptacles on the components;
a broadcast, for the mode that allows a user to broadcast data to multiple components by setting one tt and multiple trs to the same frequency, or, if the trs are set at different frequencies, the tt may broadcast to those separate frequencies;
a wireless system with ctc, for the case that the ctc dynamically re-routs each data path by assigning the virture wireless path (vwp) to different carrier frequencies to ensure qos;
a module translator controller, for translating the communication protocol when the transmitter and receiver protocols are not the same;
a module lower layer switch, for multiplexing and/or spreading for the tdma, the fdma, tds, fds, etc, tightly connected to said Translator Controller;
a module upper layer switch, for optional frequency-hopping switch (ex. firmware controlled phy), tightly connected to said Lower Layer Switch;
a module, component rf, for physical interface layer such as anntenas with baseband;
a router, for routing the data from on physical wireless device to another physical wireless device. the router provides wireless connectivity among multiple wireless devices whose communication protocols may not be the same;
a module data router, for checking the source and destination address, and it asserts and/or converts the da field in the packet header;
a component tt, for representing the tt (300) in the wireless network that provides the point-to-point connection between one transmitter and one receiver regardless of the difference in the communication protocols between the transmitter and the receiver;
a component tr, for representing the tr (400) in the wireless network that provides point-to-point connection between one transmitter and one receiver regardless of the difference in the communication protocols between the transmitter and the receiver;
a component tt-broadcast, for representing a tt with broadcasting capability (to the receivers with various communication protocols);
a component receiver-pc, for representing one of many receivers that may convert the protocol of the received packet to another protocol for the pc (612), operationally connected to said TT-Broadcast;
a component receiver-hdtv-1, for representing one of many receivers that converts the received signal to hdtv format, operationally connected to said TT-Broadcast;
a component ctc—multiple_connect, for representing a ctc with multiple groups of wireless channel connection;
a component tr/tt-pc, for providing wireless interface to the pc or other pc centric devices, operationally connected to said CTC—Multiple_Connect;
a component tr/tt-hdtv, for providing wireless interface to the (hd)tv or other entertainment devices, operationally connected to said CTC—Multiple_Connect;
a component tr/tt-cam, for providing wireless interface to camera/camcoder or other mobile devices, operationally connected to said CTC—Multiple_Connect;
a component tr/tt-settop, for providing wireless interface to the settop box or other gateway devices, operationally connected to said CTC—Multiple_Connect; and
a component tr/tt-dvd/vcr, for providing wireless interface to dvd/vcr or other storage devices, operationally connected to said CTC—Multiple_Connect.

19. The method to support simultaneous wireless connection of multiple media components as recited in claim 18, further comprising:
a module multi-freq-gen, for producing different mixer frequencies for the modulation of the phys to match with the modulation of the source and destination phys, operationally connected to said PHY-B, and operationally connected to said PHY-A.

20. The method to support simultaneous wireless connection of multiple media components as recited in claim 18, further comprising:
a module real-time router controller, for assigning the packet priority and bandwidth for the real-time signals, operationally connected to said Data Router.
